(19) United States
(12) Patent Application Publication
(10) Pub. No.: US 2025/0236490 A1
(43) Pub. Date: Jul. 24, 2025

(54) Direction Based Remote Control of a Material Handling System

(71) Applicant: Magnetek Inc., Menomonee Falls, WI (US)

(72) Inventor: Sean Harvey, New Berlin, WI (US)

(21) Appl. No.: 19/027,084

(22) Filed: Jan. 17, 2025

Related U.S. Application Data
(60) Provisional application No. 63/622,411, filed on Jan. 18, 2024.

(51) Int. Cl. B66C 13/44; B66C 19/00; G05G 9/047

(52) U.S. Cl. CPC B66C 13/44; B66C 19/00; G05G 9/047; B66C 2700/082; B66C 2700/088

(57) ABSTRACT

A radio controller includes a sensor to detect orientation of the transmitter. The orientation is used in combination with a command from the joystick to control operation of the bridge and/or trolley of a material handling system. In a first operating mode, rotational orientation is divided into two intervals. When the transmitter is facing a first direction, pressing forward causes the commanded axis to travel forward. When the transmitter is facing opposite the first direction, pressing forward causes the commanded axis to travel reverse. In a second operating mode, rotational orientation is divided into four intervals. A forward motion will control either the trolley or bridge in the direction of the joystick as a function of the transmitter orientation. In a third operating mode, displacement of the joystick will cause a vector command for the material handling system in the direction the joystick is pressed.

### CROSS-REFERENCE TO RELATED APPLICATIONS

This application claims priority to U.S. Provisional Application Ser. No. 63/622,411, filed Jan. 18, 2024, the entire contents of which is incorporated herein by reference.

### BACKGROUND OF THE INVENTION

### Field of the Invention

The subject matter disclosed herein relates to controlling operation of a material handling system. More specifically, orientation of a radio transmitter is monitored and the orientation is used to generate command signals for operation of the material handling system.

### Description of Related Art

As is known to those skilled in the art, material handling systems are widely used to lift heavy loads. A typical material handling system includes a hoist having at least one motor used to operate a cable or chain drive to raise and lower a hook, a magnet, a grapple, or other load attachment device. In some applications, the hoist may be mounted on a trolley, which is, in turn, mounted on a bridge. The trolley is configured to travel side-to-side along the bridge, and the bridge is configured to travel along rails to position the hoist at any location between the rails. Motors and drive trains may be mounted to the trolley and to the bridge to provide propulsion for the trolley and bridge.

In some applications, control of the material handling system may be performed by an operator in a cab mounted on the bridge. In other applications, control is performed by an operator standing on the floor. For operators on the floor, there are two common control options. In a first option, a pendant is provided which hangs down from the bridge and includes buttons to actuate the motors for the bridge, trolley, and/or hoist. The pendant is provided at a fixed location or may slide along the bridge but for any given system is consistently located on one side of the bridge and provides a consistent orientation for the operator with respect to the hoist during operation. In a second option, a radio controller is provided, which allows an operator greater freedom of motion with respect to the material handling system. The operator may move around and stand at either end of the bridge to observe the trolley moving side-to-side along the bridge. Similarly, the operator may stand on either side of the bridge or at any location along the rails to observe the bridge travelling along the rails.

However, this freedom of movement for the operator is not without certain drawbacks. The radio controller may include a joystick controller with three hundred sixty degrees of motion to command operation of both the bridge and trolley. Optionally, the radio controller may include paddle controllers which just move forward and backward or side-to-side to separately control motion of the bridge and trolley. In either configuration, the radio controller defines motion of the joystick or paddle in a first direction as corresponding to motion of the bridge and/or trolley in a first direction and motion of the joystick or paddle in a second direction as corresponding to motion of the bridge and/or trolley in a second direction. When the operator faces the bridge or trolley in the first direction, the controls are intuitive. In other words, pushing the joystick or paddle in the first direction (e.g., away from the operator) causes the bridge or trolley to move in the first direction (i.e., away from the operator) and pushing the joystick or paddle in the second direction (e.g., toward the operator) causes the bridge or trolley to move in the second direction (e.g., toward the operator). In contrast, when the operator faces the bridge or trolley in the second direction, opposite the first direction, and holds the radio controller in the same orientation with respect to the operator, operation of the radio controls becomes inverted with respect to the bridge or trolley. As a result, pushing the joystick or paddle away from the operator will now cause the bridge or trolley to travel towards the operator and pushing the joystick or paddle toward the operator will now cause the bridge or trolley to travel away from the operator. The different response of the material handling system as a function of the orientation of the radio controller can confuse an operator causing the operator to issue a command in an incorrect direction. Commands in an incorrect direction could cause damage to a load or equipment in the proximity of a load being moved by the material handling system.

Thus, it would be desirable to provide an improved system and method for controlling operation of a material handling system with a radio controller.

### BRIEF DESCRIPTION OF THE INVENTION

The subject matter disclosed herein describes an improved system and method for controlling operation of a material handling system with a radio controller. A sensor within the radio transmitter detects an orientation of the transmitter. The orientation of the transmitter is used in combination with a command from the joystick to control operation of the bridge and/or trolley of the material handling system. The radio transmitter may be operated in one of three operating modes. In a first operating mode, the rotational orientation of the transmitter is divided into two, one hundred eighty-degree intervals. If the transmitter is facing a first direction, a forward press on the joystick will cause the commanded axis to travel forward. If the transmitter is facing a second direction, opposite the first direction, the forward press on the joystick will cause the commanded axis to travel in reverse. However, the reverse travel corresponds to the direction in which the joystick was pressed. Similarly, left and right motions of the joystick will control operation of the commanded axis in opposite directions when the transmitter is located in opposite intervals. In a second operating mode, the rotational orientation of the transmitter is divided into four, ninety-degree intervals. A single forward or reverse motion of the joystick will control either the trolley or bridge in the direction of the joystick as a function of which interval the transmitter is oriented. In a third operating mode, the transmitter may be oriented in any direction. Displacement of the joystick will cause a vector command for the material handling system in the direction the joystick is pressed. This vector command is resolved into a two-dimensional command, providing a first command to the bridge and a second command to the trolley.

According to one embodiment of the invention, a transmitter for a material handling system includes at least one joystick, a sensor, memory, and a processor. The at least one joystick is configured to be selectively deflected in a first direction and in a second direction, where the second direction is opposite the first direction. The at least one joystick is configured to generate a first reference signal corresponding to the first direction and to generate a second reference signal corresponding to the second direction. The sensor is configured to generate at least one feedback signal corresponding to an orientation of the transmitter with respect to a plane of travel for the material handling system. The memory is configured to store instructions, and the processor is configured to execute the instructions. The processor receives the at least one feedback signal from the sensor and the first and second reference signals from the at least one joystick. The processor generates a first command signal in a first direction for an axis of motion in the material handling system when the processor receives the first reference signal and the at least one feedback signal defines a first orientation of the transmitter, and the processor generates a second command signal in the first direction for the axis of motion in the material handling system when the processor receives the second reference signal and the at least one feedback signal defines a second orientation of the transmitter. A transceiver is configured to transmit the first and second command signals to a receiver for the material handling system.

According to one aspect of the invention, the axis of motion is a first axis of motion, and the at least one joystick is further configured to be selectively deflected in a third direction and in a fourth direction, where the fourth direction is opposite the third direction. The at least one joystick is configured to generate a third reference signal corresponding to the third direction and to generate a fourth reference signal corresponding to the fourth direction. The processor is further configured to receive the third and fourth reference signals from the at least one joystick. The processor generates a third command signal in a first direction for a second axis of motion in the material handling system when the processor receives the third reference signal and the at least one feedback signal is in the first orientation of the transmitter, and the processor generates a fourth command signal in the first direction for the second axis of motion in the material handling system when the processor receives the fourth reference signal and the at least one feedback signal is in the second orientation of the transmitter.

According to another aspect of the invention, the at least one joystick may include a first joystick and a second joystick. The first joystick is configured to be selectively deflected in the first direction and the second direction and to generate the first and second reference signals for the first axis of motion. The second joystick is configured to be selectively deflected in the third direction and the fourth direction and to generate the third reference signal and the fourth reference signal for the second axis of motion. Optionally, the at least one joystick includes a single joystick. The single joystick may be configured to be selectively deflected along the first direction and the second direction as well as along the third direction and the fourth direction. According to still another option, the at least one joystick includes a single joystick selectively positioned within a three hundred sixty degree arc. The single joystick may generate the first reference signal, the second reference signal, the third reference signal, and the fourth reference signal as a function of a present position of the single joystick within the three hundred sixty degree arc.

According to still other aspects of the invention, the transmitter is configured to be selectively oriented in three hundred sixty degrees of rotation, where the three hundred sixty degrees of rotation is divided into a first segment and a second segment. The first orientation of the transmitter may lie within the first segment, and the second orientation of the transmitter may lie within the second segment. Optionally, the three hundred sixty degrees of rotation is divided into a first segment, a second segment, a third segment, and a fourth segment. The first orientation of the transmitter may then lie within the first segment, and the second orientation of the transmitter may lie within the third segment.

According to yet another aspect of the invention, the processor is further configured to generate a fifth command signal in the first direction for the second axis of motion in the material handling system when the processor receives the first reference signal and the at least one feedback signal indicates the transmitter is in the second segment. The processor generates a sixth command signal in the first direction for the second axis of motion in the material handling system when the processor receives the second reference signal and the at least one feedback signal indicates the transmitter is in the fourth segment. The processor generates a seventh command signal in the first direction for the first axis of motion in the material handling system when the processor receives the fourth reference signal and the at least one feedback signal indicates the transmitter is in the second segment. The processor generates an eighth command signal in the first direction for the first axis of motion in the material handling system when the processor receives the third reference signal and the at least one feedback signal indicates the transmitter is in the fourth segment.

According to another embodiment of the invention, a method of controlling a material handling system includes receiving a reference signal at a processor from a first joystick on a transmitter for the material handling system. The reference signal is selectively a first reference signal when the first joystick is deflected in a first direction or a second reference signal when the joystick is deflected in a second direction. A feedback signal is received at the processor from a sensor mounted in the transmitter, where the feedback signal corresponds to an orientation of the transmitter with respect to a plane of travel for the material handling system. A first command signal in a first direction for a first axis of motion in the material handling system is generated when the processor receives the first reference signal and the feedback signal defines a first orientation of the transmitter. A second command signal in the first direction for the first axis of motion in the material handling system is generated when the processor receives the second reference signal and the feedback signal defines a second orientation of the transmitter. The first and the second command signals are transmitted from the transmitter to a receiver for the material handling system.

According to another aspect of the invention, an additional reference signal may be received at the processor. The additional reference signal is selectively a third reference signal corresponding to a third direction or a fourth reference signal corresponding to a fourth direction. A third command signal in a first direction for a second axis of motion in the material handling system is generated when the processor receives the third reference signal and the feedback signal is in the first orientation of the transmitter. A fourth command signal in the first direction for the second axis of motion in the material handling system is generated when the processor receives the fourth reference signal and the feedback signal is in the second orientation of the transmitter.

According to still another embodiment of the invention, a transmitter for a material handling system includes a joystick, a sensor, and a processor. The joystick is mounted on the transmitter and configured to be selectively deflected forward and reverse in at least a first direction and a second direction. The sensor is configured to generate at least one feedback signal corresponding to an orientation of the transmitter with respect to a plane of travel for the material handling system. The processor is operative to generate a first command signal having a first polarity for a first axis of motion in the material handling system when the joystick is selectively deflected in the first direction and the sensor indicates the transmitter is in a first orientation and to generate the first command signal having a second polarity for the first axis of motion in the material handling system when the joystick is selectively deflected in the first direction and the sensor indicates the transmitter is in a second orientation, where the second polarity is opposite the first polarity. A second command signal having a first polarity for a second axis of motion in the material handling system is generated when the joystick is selectively deflected in the second direction and the sensor indicates the transmitter is in the first orientation, and the second command signal having a second polarity for the second axis of motion in the material handling system is generated when the joystick is selectively deflected in the second direction and the sensor indicates the transmitter is in the second orientation, where the second polarity for the second axis of motion is opposite the first polarity for the second axis of motion.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is an exemplary environment incorporating one embodiment of the present invention;

FIG. 2 is a partial perspective view of elements of the drive train for one axis of motion in the exemplary environment of FIG. 1;

FIG. 3 is a block diagram representation of a radio receiver and a motor controller shown in FIG. 2;

FIG. 4 is a perspective view of a radio transmitter;

FIG. 5 is a block diagram representation of the radio transmitter of FIG. 4;

FIG. 6 is a block diagram representation of a portion of the data stored in the memory device of the motor controller of FIG. 3;

FIG. 7 is a block diagram representation of a motor control module executing in the processor of FIG. 3;

FIG. 8 is a top plan view of a trolley mounted on a bridge which is, in turn, mounted on rails for an overhead material handling system;

FIG. 9 is a top plan view illustrating a direction of a command for the bridge when a radio transmitter is in a first operating mode, in a first orientation, and a joystick is pressed either forward or reverse;

FIG. 10 is a top plan view illustrating a direction of a command for the bridge when the radio transmitter is in the first operating mode, in a second orientation, and the joystick is pressed either forward or reverse;

FIG. 11 is a top plan view illustrating a direction of a command for the trolley when the radio transmitter is in the first operating mode, in the first orientation, and the joystick is pressed either left or right;

FIG. 12 is a top plan view illustrating a direction of a command for the trolley when the radio transmitter is in the first operating mode, in the second orientation, and the joystick is pressed either left or right;

FIG. 13 is a top plan view illustrating a direction of a command for the bridge when the radio transmitter is in a second operating mode, in a first orientation, and the joystick is pressed either forward or reverse;

FIG. 14 is a top plan view illustrating a direction of a command for the bridge when the radio transmitter is in a second operating mode, in a third orientation, and the joystick is pressed either forward or reverse;

FIG. 15 is a top plan view illustrating a direction of a command for the trolley when the radio transmitter is in a second operating mode, in a first orientation, and the joystick is pressed either left or right;

FIG. 16 is a top plan view illustrating a direction of a command for the trolley when the radio transmitter is in a second operating mode, in a third orientation, and the joystick is pressed either left or right;

FIG. 17 is a top plan view illustrating a direction of a command for the trolley when the radio transmitter is in a second operating mode, in a fourth orientation, and the joystick is pressed either forward or reverse;

FIG. 18 is a top plan view illustrating a direction of a command for the trolley when the radio transmitter is in a second operating mode, in a second orientation, and the joystick is pressed either forward or reverse;

FIG. 19 is a top plan view illustrating a direction of a command for the bridge when the radio transmitter is in a second operating mode, in a fourth orientation, and the joystick is pressed either left or right;

FIG. 20 is a top plan view illustrating a direction of a command for the bridge when the radio transmitter is in a second operating mode, in a second orientation, and the joystick is pressed either left or right; and

FIG. 21 is a top plan view illustrating a direction of a command for the trolley when the radio transmitter is in a third operating mode and the joystick is pressed forward.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE INVENTION

The various features and advantageous details of the subject matter disclosed herein are explained more fully with reference to the non-limiting embodiments described in detail in the following description.

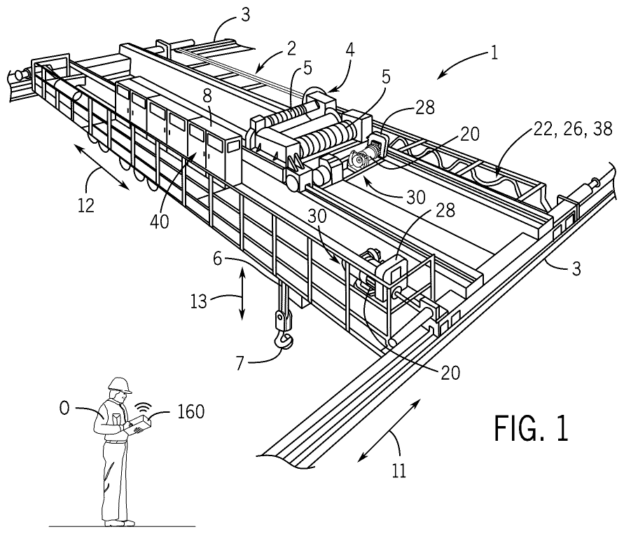

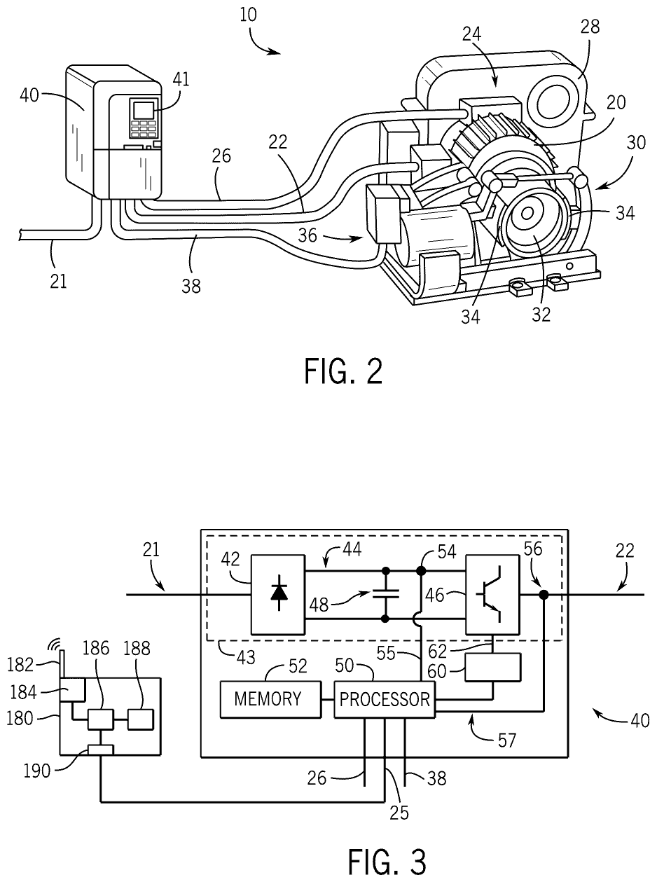

Turning initially to FIG. 1, an exemplary embodiment of a material handling system 1 incorporating the present invention is illustrated. It is contemplated that the material handling system 1 may have numerous configurations according to the application requirements. According to one embodiment, the material handling system 1 may include a bridge 2 configured to move in a first axis of motion 11 along a pair of rails 3 located at either end of the bridge 2. A trolley 4 may be mounted on the bridge 2 to move in a second axis of motion 12, generally perpendicular to the first axis of motion 11, along the span of the bridge 2. One or more sheaves 5, also referred to as drums, may be mounted to the trolley 4, around which a cable 6 is wound. The sheave 5 may be rotated in either direction to wind or unwind the cable 6 around the sheave 5. The cable 6 is operatively connected to a hook block 7 or any other lifting fixture such that the hook block may be connected to a load and move in a third axis of motion 13, generally perpendicular to each of the first and the second axes of motions, 11 and 12. One or more control cabinets 8 housing, control devices such as a motor controller 40 (see FIG. 2) are mounted on the bridge 2. The material handling system 1 receives commands from an operator, O, on the ground via a radio 160.

Referring next to FIG. 2, an exemplary portion of the drive system 10 for one axis of motion in the material handling system 1 is illustrated. The exemplary portion of the drive system 10 includes a motor 20 controlled by the motor controller 40, also referred to herein as a motor drive. The motor controller 40 delivers a regulated voltage and/or current to the motor 20 via a set of electrical conductors 22. The magnitude and/or frequency of the voltage or current may be varied to control the speed at which the motor 20 rotates, the torque produced by the motor 20, or a combination thereof. A feedback device 24, such as an encoder or a resolver, is connected to the motor, typically by mounting the feedback device 24 to the output shaft at one end of the motor 20. The feedback device 24 provides to the motor controller 40, via electrical conductors 26, any suitable electrical signal, corresponding to rotation of the motor 20, as would be known in the art. A gearbox 28 may be connected to the output shaft of the motor 20 for rotating any suitable drive member at a desired speed according to the requirements of the axis of motion to which the gearbox 28 is connected. Optionally, the motor 20 may be configured to directly rotate the drive member.

A braking unit 30 is supplied to prevent undesired rotation of the motor 20. As illustrated in FIG. 2, one embodiment of the braking unit 30 includes a brake wheel 32 mounted to a shaft extending from the motor 20. Brake shoes 34 engage opposite sides of the brake wheel 32. A brake controller 36 selectively engages and disengages the brake shoes 34 to the brake wheel 32. The brake controller 36 may be, but is not limited to, an electric or a hydraulic controller receiving a command signal from the motor controller 40 via an electrical conductor 38. Optionally, the braking unit 30 may include, for example, a disc attached to the motor and may employ brake pads to engage the disc. It is contemplated that numerous other configurations of brakes may be employed without deviating from the scope of the present invention. According to still other embodiments, the braking unit 30 may be connected at any suitable location along the drive system 10 to prevent motion of the commanded axis according to application requirements.

The following definitions will be used to describe exemplary material handling systems throughout this specification. As used herein, the terms “raise” and “lower” are intended to denote the operations of letting out or reeling in a cable 6 connectable to a load handling member 7 of a material handling system 1 and are not limited to moving a load in a vertical plane. The load handling member 7 may be any suitable device for connecting to or grabbing a load, including, but not limited to, a hook block, a bucket, a clam-shell, a grapple, or a magnet. While an overhead crane may lift a load vertically, a winch may pull a load from the side. Further, an appropriately configured load handling member 7 may allow a load to unwind cable or may reel in the load by winding up the cable at any desired angle between a horizontal plane and a vertical plane.

The “cable,” also known as a “rope,” may be of any suitable material. For example, the “cable” may be made from, but is not limited to, steel, nylon, plastic, other metal or synthetic materials, or a combination thereof, and may be in the form of a solid or stranded cable, chain links, or any other combination as is known in the art.

A “run” is one cycle of operation of the motor controller 40. The motor controller 40 controls operation of the motor 20, rotating the motor 20 to cause the cable 6 to wind around or unwind from the sheave 5. A “run” may include multiple starts and stops of the motor 20 and, similarly it may require multiple “runs” to let the cable 6 fully unwind or wind completely around the sheave 5 or require multiple “runs” for a bridge or trolley to traverse their full length of travel. Further, the cable 6 need not be fully unwound from or wound around the sheave 5 and a bridge or trolley need not travel to end-of-travel limit before reversing direction of rotation of the motor 20. In addition, direction of rotation of the motor 20 may be reversed within a single run. A “run” may include a temporary pause at zero speed before resuming rotation of the motor. Each “run” begins and ends with the motor controller 40 enabling and disabling control of the motor 20 by the motor controller.

With reference next to FIG. 3, the motor controller 40 receives a command signal 25 from any suitable operator interface. The operator interface may be, but is not limited to, a keypad 41 mounted on the motor controller 40, a remote industrial joystick with a wired connection to the motor controller 40, or a radio receiver 180 connected to the motor controller receiving a wireless signal from a corresponding radio transmitter 160. An exemplary radio transmitter 160 is shown in FIG. 4. According to the illustrated embodiment discussed herein, the motor controller 40 will be receiving command signals from a radio transmitter 160 connected to a radio receiver 180. The motor controller 40 includes an input 21, for example, one or more terminals, configured to receive power, which may be a single or multiple phase alternating current (AC) or a direct current (DC) power source. A power conversion section 43 of the motor controller 40 converts the input power 21 to a desired power at an output 22 configured to connect to the motor 20. The output 22 may similarly be a single or multiple phase AC or a DC output, according to the application requirements. According to the illustrated embodiment, the power conversion section 43 includes a rectifier section 42 and an inverter section 46, converting a fixed AC input to a variable amplitude and variable frequency AC output. Optionally, other configurations of the power conversion section 43 may be included according to the application requirements. The rectifier section 42 is electrically connected to the power input 21. The rectifier section 42 may be either passive, such as a diode bridge, or active, including controlled power electronic devices such as transistors. The input power 21 is converted to a DC voltage present on a DC bus 44. The DC bus 44 includes a bus capacitance 48 connected across the DC bus 44 to smooth the level of the DC voltage present on the DC bus 44. As is known in the art, the bus capacitance 48 may include a single or multiple capacitors arranged in serial, parallel, or a combination thereof according to the power ratings of the motor controller 40. An inverter section 46 converts the DC voltage on the DC bus 44 to the desired output power for the motor 20 according to switching signals 62.

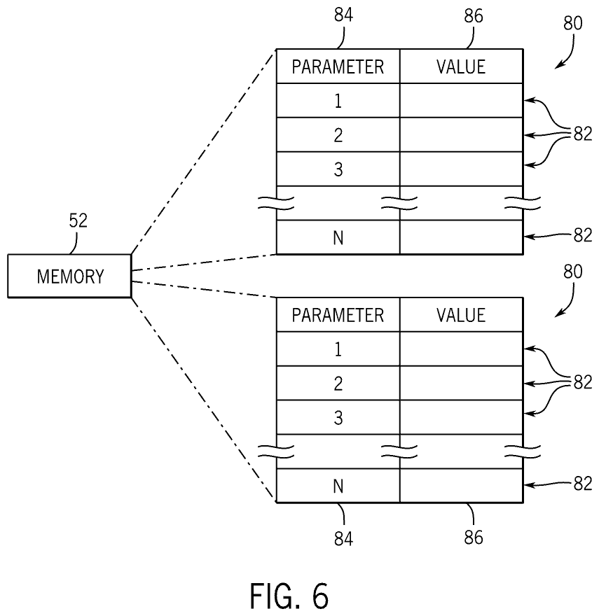

The motor controller 40 further includes a processor 50 connected to a memory device 52. It is contemplated that the processor 50 may be a single processor or multiple processors operating in tandem. It is further contemplated that the processor 50 may be implemented in part or in whole on a field programmable gate array (FPGA), an application specific integrated circuit (ASIC), a logic circuit, or a combination thereof. The memory device 52 may be a single or multiple electronic devices, including static memory, dynamic memory, or a combination thereof. The memory device 52 preferably stores parameters 82 of the motor controller 40 and one or more programs, which include instructions executable on the processor 50. Referring also to FIG. 6, a parameter table 80 includes an identifier 84 and a value 86 for each of the parameters 82. The parameters 82 may, for example, configure operation of the motor controller 40 or store data for later use by the motor controller 40.

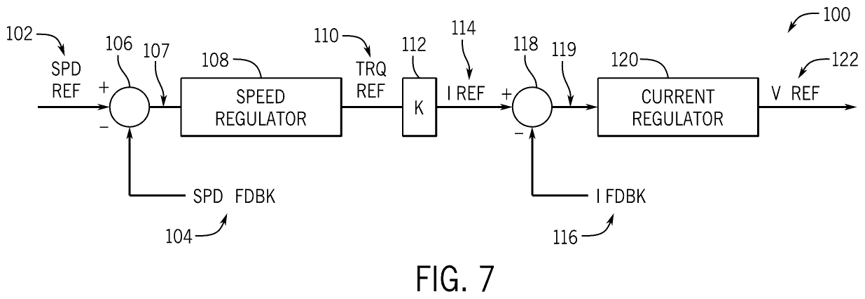

Referring also to FIG. 7, the processor 50 is configured to execute a motor control module 100 to generate a voltage reference 122 to the motor 20 corresponding to the necessary amplitude and frequency to run the motor 20 at the desired speed reference 102. The motor 20 may include a position sensor 24 connected to the motor controller 40 via an electrical connection 26 to provide a position feedback signal corresponding to the angular position of the motor 20. The processor 50 determines a speed feedback signal 104 as a function of the rate of change of the position feedback signal over time. The processor 50 receives feedback signals, 55 and 57, from sensors, 54 and 56 respectively. The sensors, 54 and 56, may include one or more sensors generating signals, 55 and 57, corresponding to the amplitude of voltage and/or current present at the DC bus 44 or at the output 22 of the motor controller 40, respectively. The switching signals 62 may be determined by an application specific integrated circuit 60 receiving reference signals from a processor 50 or, optionally, directly by the processor 50 executing the stored instructions. The switching signals 62 are generated, for example, as a function of the feedback signals, 55 and 57, received at the processor 50.

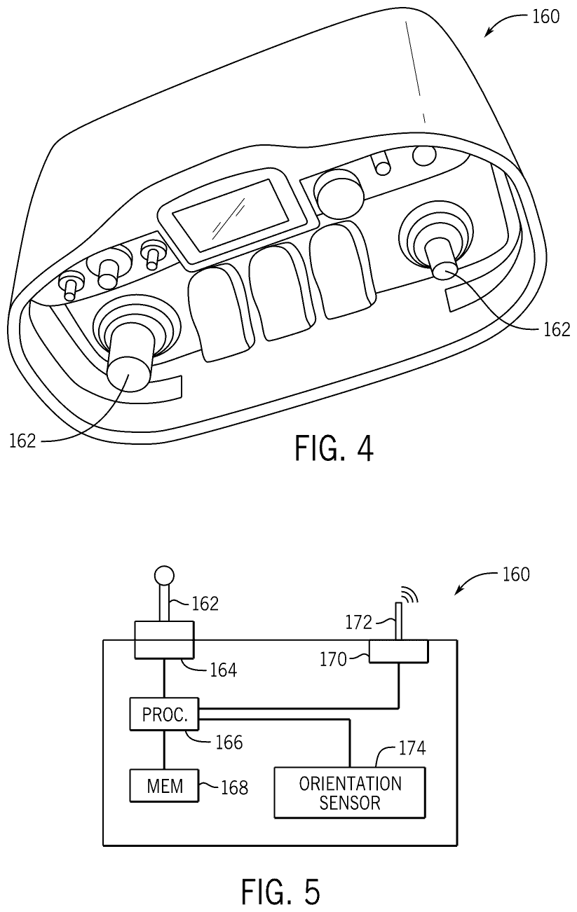

Turning next to FIGS. 4 and 5, an exemplary radio transmitter 160 is illustrated. The radio transmitter 160 includes at least one joystick 162 by which an operator, O, is able to control operation of the material handling system 1. An input interface 164 converts the deflection of the joystick 162 into reference signals for different axes of the material handling system 1. According to one aspect of the invention, a joystick 162 may be a lever or paddle configured to move along a single axis, such as forward and reverse or left and right. A pair of single-axis joysticks 162 may be provided, where one joystick controls operation of a bridge 2 and the other joystick controls operation of a trolley 4. According to another aspect of the invention, the joystick 162 may be configured to move along two axes of motion. A single joystick 162 may move either forward and reverse or left to right. A guide plate may be mounted to a surface of the transmitter to provide intersecting channels defining the two axes of motion. According to still another aspect of the invention, the joystick 162 may be positioned at any orientation within three hundred sixty degrees of rotation around a neutral, center position. The joystick 162 is configured to generate one or more reference signals indicating a direction and magnitude of deflection.

These reference signals are received at inputs to a processor 166. The processor 166 is in communication with memory 168 within the radio transmitter 160 to execute instructions stored in memory. The radio transmitter 160 also includes an orientation sensor 174. The orientation sensor may be a magnetometer, an accelerometer, a gyroscope, or a combination thereof. The orientation sensor 174 generates one or more feedback signals to the processor 166 corresponding to the current orientation of the radio transmitter 160 with respect to a plane of travel for the material handling system 1 being controlled by the radio transmitter. The feedback signals define a current orientation of the radio transmitter 160 in at least two dimensions and, preferably in three dimensions. The feedback signals may correspond to a yaw, pitch, and roll of the radio transmitter 160. Optionally, the orientation sensor may include a control circuit configured to perform some initial processing on the raw angle signals and may generate an angle feedback signal corresponding to an angle of orientation for the radio transmitter 160 between zero and three hundred sixty degrees with respect to the plane of travel for the material handling system 1.

The processor 166 is configured to transmit data to the radio receiver 180 mounted on the bridge 2 of the material handling system 1. The processor 166 creates data packets for a transceiver interface 170, and the transceiver interface 170 transmits the data packets via an antenna 172 to the radio receiver 180. According to one aspect of the invention, the radio transmitter 160 transmits data corresponding to the deflection of the joystick 162 and the orientation of the transmitter 160 directly to the receiver 180. According to another aspect of the invention, the radio transmitter 160 performs some initial processing of the deflection of the joystick 162 and the orientation of the transmitter 160 to determine command signals for bridge 2 and/or trolley 4. The transmitter 160 may then transmit the processed data to the receiver 180. The processed data may be, for example, a speed command for the bridge 2 and/or trolley 4 determined as a function of the deflection of the joystick 162 and the orientation of the transmitter 160.

With reference again to FIG. 3, the radio receiver 180 includes an antenna 182 and a transceiver interface 184 for communication with the radio transmitter 160. Data packets received from the transmitter 160 are passed to a processor 186 in the radio receiver 180. The processor 186 is in communication with memory 188 within the radio receiver 180 to execute instructions stored in memory. According to one aspect of the invention, the radio receiver 180 receives data corresponding to the deflection of the joystick 162 and the orientation of the transmitter 160 from the receiver 180. The radio receiver 180 then performs processing of the deflection of the joystick 162 and the orientation of the transmitter 160 to determine a speed command for the bridge 2 and/or trolley 4 as a function of the deflection of the joystick 162 and the orientation of the transmitter 160. According to another aspect of the invention, the radio receiver 180 receives the speed command for the bridge 2 and/or trolley 4 from the radio transmitter 160. The radio receiver 180 then provides the command signal 25 for the motor drive 40 corresponding to the bridge 2 and/or trolley 4 via an output interface 190.

In operation, the processor 50 for a motor drive 40 receives the command signal 25 indicating a desired operation of one or more of the motors 20 in the material handling system 1 and provides a variable amplitude and frequency voltage output 22 to the motor 20 responsive to the command signal 25. The command signal 25 is received by the processor 50 and converted, for example, from discrete digital signals or an analog signal to an appropriately scaled speed reference 102 for use by the motor control module 100. With reference next to FIG. 7, an exemplary closed loop controller for the motor drive 40 is illustrated. When closed loop operation of the motor drive 40 is desired, the speed reference 102 and a speed feedback signal 104 enter a summing junction 106, resulting in a speed error signal 107. The speed feedback signal 104 may be derived from a position feedback signal generated by the position sensor 24. Optionally, the speed feedback signal 104 may be derived from an internally determined position signal generated, for example, by a position observer. The speed error signal 107 is provided as an input to a speed regulator 108. The speed regulator 108, in turn, determines the required torque reference 110 to minimize the speed error signal 107, thereby causing the motor 20 to run at the desired speed reference 102. If open loop operation of the motor drive 40 is desired, where open loop operation does not include a speed feedback signal, the speed reference signal 102 may be scaled directly to a torque reference 110 that would result in the motor 20 operating at the desired speed reference 102. A scaling factor 112 converts the torque reference 110 to a desired current reference 114. The current reference 114 and a current feedback signal 116, derived from a feedback signal 57 measuring the current present at the output 22 of the motor drive 40, enter a second summing junction 118, resulting in a current error signal 119. The current error signal is provided as an input to the current regulator 120. The current regulator 120 generates the voltage reference 122 which will minimize the error signal 119, again causing the motor 20 to run at the desired speed reference 102. This voltage reference 122 is used to generate the switching signals 62 which control the inverter section 46 to produce a variable amplitude and frequency output voltage 22 to the motor 20.

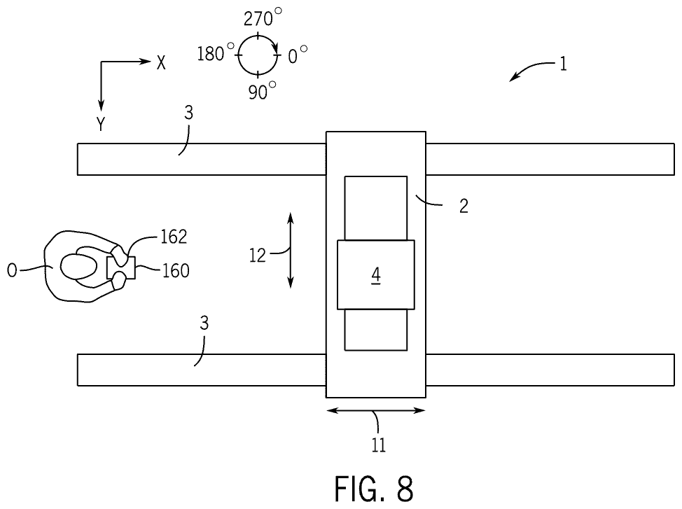

With reference next to FIG. 8, an overhead crane is shown with a bridge 2 configured to move in a first axis of motion 11 along two rails 3. The overhead crane shown in FIG. 8 also includes a trolley 4 configured to move along the bridge 2 in a second axis of motion 12. An operator, O, is able to control operation of the overhead crane via the joystick 162 mounted on the radio transmitter 160. The orientation of the radio transmitter is used in combination with the joystick or paddle(s) to generate commands for motion of the material handling system. A cartesian coordinate system is defined for use by the material handling system. An X-axis corresponds to travel along the rails 3. A Y-axis corresponds to travel along the bridge 2. A Z-axis corresponds to raising/lowering of the hook. A plane of travel for the material handling system is defined in the x-y axes with a first dimension being in the direction of travel for the bridge and a second dimension being in the direction of travel for the trolley. One orientation, such as the positive direction of travel for the bridge, is defined as zero degrees. A rotational orientation of ninety degrees may then define the positive direction of travel for the trolley, a rotational orientation of one hundred eighty degrees defines the negative direction of travel for the bridge, and a rotational orientation of two hundred seventy degrees defines the negative direction of travel for the trolley.

According to one aspect of the invention, the radio system may be configured to operate in one of three operating modes. In a first operating mode, the rotational orientation is divided into two segments, where each segment spans one hundred eighty-degrees. One of the segments faces a forward direction of travel and the other segment faces a reverse direction of travel. For purposes of discussion herein, a forward direction of travel of the bridge 2 in FIG. 8 corresponds to a first segment, and a reverse direction of travel of the bridge 2 corresponds to a second segment. The first segment, therefore, extends between two hundred seventy-degrees and ninety-degrees, and the second segment extends between ninety-degrees and back to two hundred seventy-degrees. When the radio transmitter 160 rotates, the orientation sensor 174 detects the orientation of the radio transmitter 160 and determines in which direction the front of the transmitter 160 is facing. The orientation sensor 174 generates a feedback signal corresponding to the rotational orientation of the transmitter.

According to one aspect of the invention, a homing routine may be incorporated into the transmitter 160. The homing routine may be executed when the transmitter 160 is powered up. The operator, O, places the transmitter 160 in a desired orientation for zero degrees and powers up the transmitter. The transmitter 160 will default its initial position to zero degrees. According to another aspect of the invention, the transmitter 160 may include a button, switch, or other actuator to set the orientation of the transmitter 160 to zero. This manual homing routine allows an operator, O, to place the transmitter 160 at a desired orientation after the transmitter 160 has been powered up and set the angle for the transmitter 160 to zero degrees, where the zero degrees corresponds to the forward direction for the bridge 2. According to still another aspect of the invention, the transmitter 160 starts at zero degrees upon power up, and the orientation sensor 174 maintains a continuous record of the orientation of the transmitter 160 subsequent to power up. A button on the transmitter 160 may be utilized to capture a present value of the orientation for the transmitter 160 and assign the present value as the forward direction for the bridge. The first segment may then be defined as plus and minus ninety degrees from the stored value, and the second segment is defined as the remaining portion of the three hundred sixty degree arc.

As indicated above, the power-up routine or a homing routine may set the orientation angle for the transmitter 160 equal to an x-y axes defined for the material handling system 1. However, in some applications, the angle generated by the transmitter 160 may be offset from the orientation of x-y axes. An offset value may be stored in the transmitter 160 and/or receiver 180 to compensate for the difference in the orientation between the axes defined by the orientation sensor 174 and the axes of the material handling system. The front of the transmitter 160 is then determined to be oriented in either the first segment or the second segment of the x-y axes. It is contemplated that the transmitter 160, the receiver 180, or a combination thereof may be configured to perform steps in the processing of the command signal and the orientation signal. For convenience, the radio transmitter 160 and radio receiver 180 will be referred to in combination as the radio controller with steps in the process being performed by either the radio transmitter 160 or the radio receiver 180.

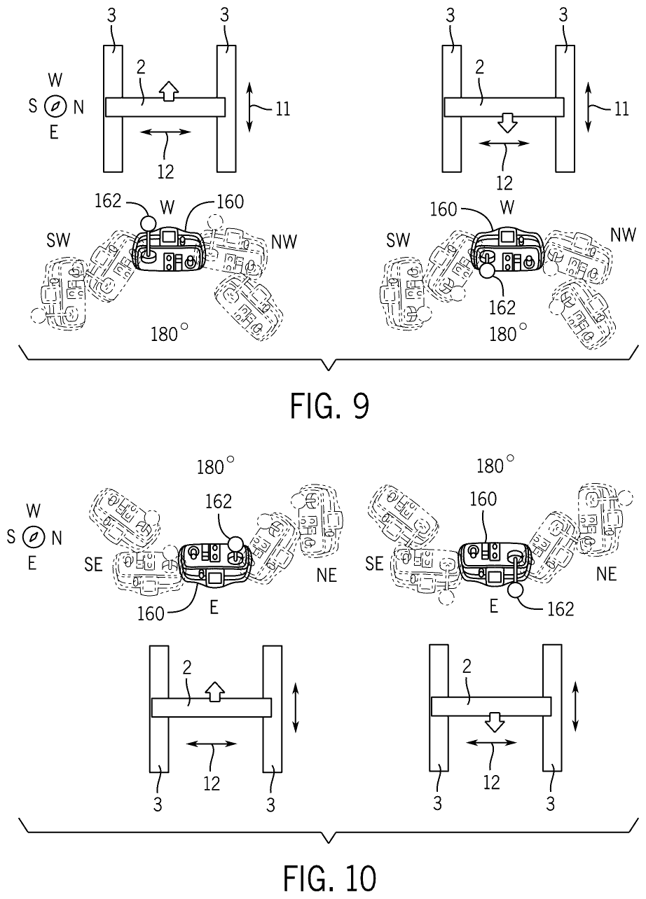

The radio transmitter also generates command signals for desired operation of the bridge 2 and/or trolley 4 of the hoist 1 shown in FIG. 8. With reference next to FIGS. 9-12, operation in the first operating mode will be discussed. FIGS. 9 and 10 illustrate commanded motion of the bridge 2. In FIG. 9, the transmitter 160 is illustrated as oriented in the first segment. In the left half of FIG. 9, the joystick 162 is pressed forward, and in the right half of FIG. 9, the joystick is pressed reverse. As illustrated by the arrows on the bridge 2, the bridge is commanded to move forward when the joystick 162 is pressed forward, and the bridge is commanded to move reverse when the joystick 162 is pressed reverse. In FIG. 10, the operator is facing the opposite direction such that the transmitter 160 is oriented in the second segment. In the left half of FIG. 10, the joystick 162 is pressed reverse, and in the right half of FIG. 9, the joystick is pressed forward. As illustrated by the arrows on the bridge 2, the bridge is commanded to move forward when the joystick 162 is pressed reverse, and the bridge is commanded to move reverse when the joystick 162 is pressed forward.

Although the directions the joystick 162 is deflected are logically opposite, the bridge 2 will always travel in the same physical direction that the joystick 162 is deflected. In the left half of FIG. 9 the joystick is deflected forward with respect to the transmitter 160. This deflections generates a first reference signal corresponding to the joystick being deflected forward, and the processor 166 in the transmitter 160 receives this first reference signal. The processor 166 also reads the present orientation of the transmitter 160 from the orientation sensor 174. In the first orientation, shown in FIG. 9, the transmitter 160 detects that the front of the transmitter 160 is in the same direction as the forward direction for the bridge 2 and generates a forward command for the bridge 2. In the left half of FIG. 10, the joystick is deflected backward with respect to the transmitter 160. This deflection generates a second reference signal corresponding to the joystick being deflected backward, and the processor 166 in the transmitter receives this second reference signal. The processor 166 also reads the present orientation of the transmitter 160 from the orientation sensor 174. In the second orientation, shown in FIG. 10, the transmitter 160 detects that the front of the transmitter 160 is in the same direction as the reverse direction for the bridge 2. Because the transmitter 160 is intended to command the bridge 2 to travel in the same direction that the joystick 162 is deflected, the transmitter generates a forward command for the bridge despite the joystick 162 being deflected in the reverse direction. The transmitter 160 determines motion commands based on the orientation of the transmitter 160 and direction that the joystick has been pressed. The transmitter detects that in both instances the joystick 162 is pressed in the same direction as the forward direction of the bridge 2. Thus, for the operating states illustrated in the left side of both FIG. 9 and FIG. 10, the transmitter 160 generates a command signal in the same direction (i.e., forward) to the bridge 2. Similarly, the transmitter 160 generates a command signal in the same direction (i.e., reverse) for the operating states illustrated in the right side of both FIG. 9 and FIG. 10.

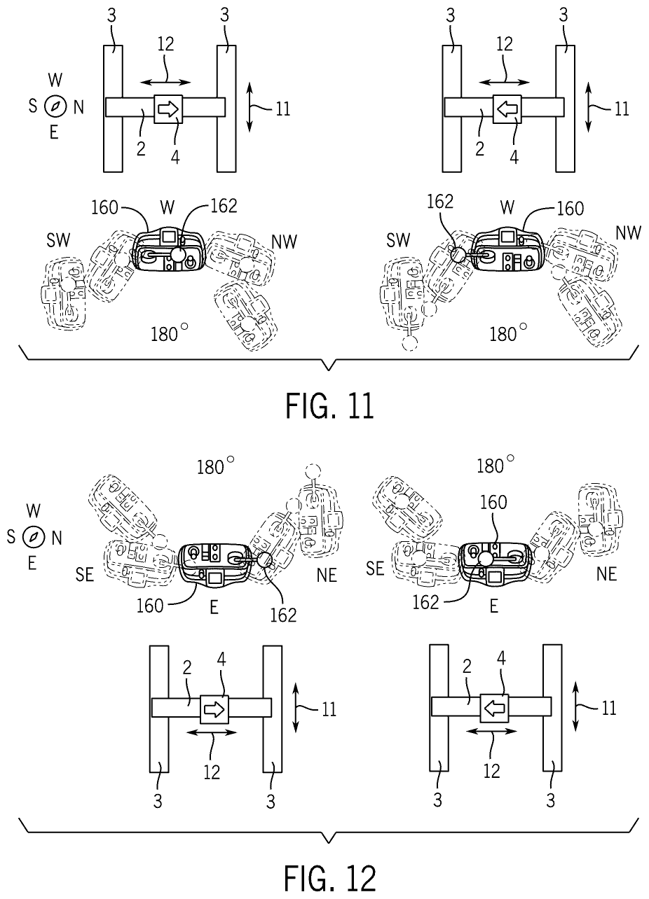

FIGS. 11 and 12 illustrate commanded motion of the trolley 4. Operation of the trolley 4 is similar to the above-described operation of the bridge 2 except that the joystick 162 is deflected to the left or right rather than forward and reverse as shown in FIGS. 9 and 10. In FIG. 11, the transmitter 160 is again oriented in the first segment. In the left half of FIG. 11, the joystick 162 is pressed to the right, and in the right half of FIG. 11, the joystick is pressed to the left. As illustrated by the arrows on the trolley 4, the trolley is commanded to move to the right when the joystick 162 is pressed right, and the bridge is commanded to move left when the joystick 162 is pressed left. In FIG. 12, the transmitter 160 is again oriented in the second segment. In the left half of FIG. 12, the joystick 162 is pressed to the left, and in the right half of FIG. 12, the joystick is pressed to the right. As illustrated by the arrows on the trolley 4, the trolley is commanded to move to the right when the joystick 162 is pressed left, and the trolley is commanded to move left when the joystick 162 is pressed right.

Similar to control of the bridge 2, the directions the joystick 162 is deflected are logically opposite, but the trolley 4 will always travel in the same physical direction that the joystick 162 is deflected.

In the left half of FIG. 11 the joystick is deflected to the right with respect to the transmitter 160. This deflection generates a first reference signal corresponding to the joystick being deflected right, and the processor 166 in the transmitter 160 receives this first reference signal. The processor 166 also reads the present orientation of the transmitter 160 from the orientation sensor 174. In the first orientation, shown in FIG. 11, the transmitter 160 detects that the front of the transmitter 160 is in the same direction as the forward direction for the bridge 2 and generates a command for the trolley 4 to travel to the right. In the left half of FIG. 12, the joystick is deflected to the left with respect to the transmitter 160. This deflection generates a second reference signal corresponding to the joystick being deflected to the left, and the processor 166 in the transmitter receives this second reference signal. The processor 166 also reads the present orientation of the transmitter 160 from the orientation sensor 174. In the second orientation, shown in FIG. 12, the transmitter 160 detects that the front of the transmitter 160 is in the same direction as the reverse direction for the bridge 2. Because the transmitter 160 is intended to command the trolley 4 to travel in the same direction that the joystick 162 is deflected, the transmitter generates a right command for the trolley 4 despite the joystick 162 being deflected in the left direction. The transmitter 160 determines motion commands based on the orientation of the transmitter 160 and direction that the joystick has been pressed. The transmitter detects that in both instances, the joystick 162 is pressed in the same direction as the right direction of travel for the trolley 4. Thus, for the operating states illustrated in the left side of both FIG. 11 and FIG. 12, the transmitter 160 generates a command signal in the same direction (i.e., right) to the trolley 4. Similarly, the transmitter 160 generates a command signal in the same direction (i.e., left) for the operating states illustrated in the right side of both FIG. 11 and FIG. 12.

In a second operating mode, the rotational orientation is divided into four segments, where each segment spans ninety degrees. One segment faces the forward direction of travel for the bridge 2. A second segment faces the forward direction of travel for the trolley 4. A third segment faces the reverse direction of travel for the bridge. A fourth segment faces the reverse direction of travel for the trolley 4. According to the illustrated embodiment, the first segment extends between three hundred fifteen degrees and forty-five degrees. The second segment extends between forty-five degrees and one hundred thirty-five degrees. The third segment extends between one hundred thirty-five degrees and two hundred twenty-five degrees. The fourth segment extends between two hundred twenty-five degrees and back to three hundred fifteen degrees. When the radio transmitter 160 rotates, the orientation sensor 174 detects the orientation of the radio transmitter 160 and determines in which direction the front of the transmitter 160 is facing. The orientation sensor 174 generates a feedback signal corresponding to the rotational orientation of the transmitter. This angle may correspond directly to the x-y axes defined for the material handling system 1. However, in some applications, the angle generated by the transmitter 160 may be offset from the orientation of x-y axes. An offset value may be stored in the transmitter 160 and/or receiver 180 to compensate for the difference in the orientation between the axes defined by the orientation sensor 174 and the axes of the material handling system. The front of the transmitter 160 is then determined to be oriented in one of the four segments of the x-y axes.

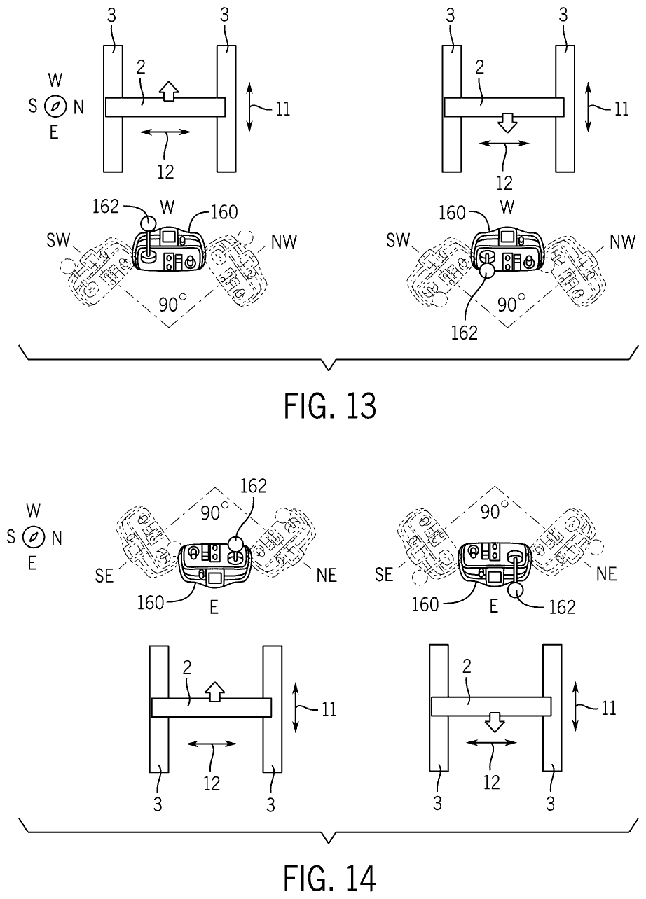

With reference next to FIGS. 13-20, operation in the second operating mode will be discussed. FIGS. 13 and 14 illustrate commanded motion of the bridge 2 with the joystick 162 moving in a forward or reverse direction. In FIG. 13, the transmitter 160 is oriented forward in the first segment. In the left half of FIG. 13, the joystick 162 is pressed forward, and in the right half of FIG. 13, the joystick is pressed reverse. As illustrated by the arrows on the bridge 2, the bridge is commanded to move forward when the joystick 162 is pressed forward, and the bridge is commanded to move reverse when the joystick is pressed reverse. In FIG. 14, the operator is facing the opposite direction from FIG. 13 such that the transmitter 160 is oriented forward in the third segment. In the left half of FIG. 14, the joystick 162 is pressed reverse, and in the right half of FIG. 14, the joystick is pressed forward. As illustrated by the arrows on the bridge 2, the bridge is commanded to move forward when the joystick 162 is pressed reverse, and the bridge is commanded to move reverse when the joystick is pressed forward. Although the directions the joystick 162 is deflected with respect to the transmitter 160 are logically opposite, the bridge 2 will always travel in the same physical direction that the joystick 162 is deflected.

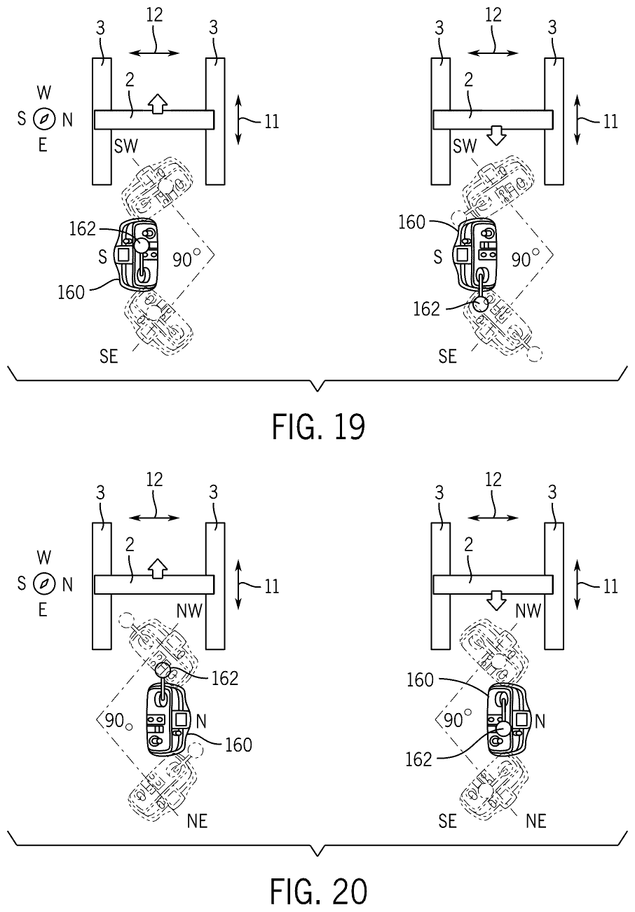

With four segment operation, the bridge 2 may also be commanded by left and right motion of the joystick 162. With reference next to FIGS. 19 and 20, the bridge 2 is commanded by moving the joystick 162 left or right. In FIG. 19, the transmitter 160 is oriented forward in the fourth segment. In the left half of FIG. 19, the joystick 162 is pressed to the right, and in the right half of FIG. 13, the joystick is pressed to the left. As illustrated by the arrows on the bridge 2, the bridge is commanded to move forward when the joystick 162 is pressed right, and the bridge is commanded to move reverse when the joystick is pressed left. In FIG. 20, the operator is facing the opposite direction from FIG. 19 such that the transmitter 160 is oriented forward in the second segment. In the left half of FIG. 20 the joystick 162 is pressed to the left, and in the right half of FIG. 20, the joystick is pressed to the right. As illustrated by the arrows on the bridge 2, the bridge is commanded to move forward when the joystick 162 is pressed left, and the bridge is commanded to move reverse when the joystick is pressed right. Although the directions the joystick 162 is deflected with respect to the transmitter 160 are logically opposite, the bridge 2 will always travel in the same physical direction that the joystick 162 is deflected.

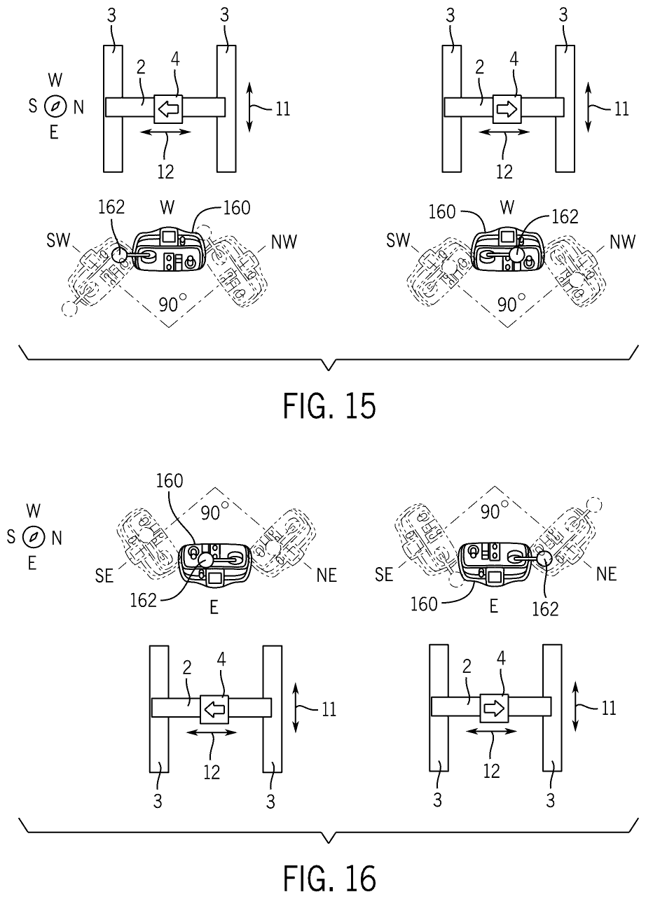

FIGS. 15 and 16 illustrate commanded motion of the trolley 4 with the joystick 162 moving in a left and right direction. In FIG. 15, the transmitter 160 is oriented forward in the first segment. In the left half of FIG. 15, the joystick 162 is pressed to the left, and in the right half of FIG. 15, the joystick 152 is pressed to the right. As illustrated by the arrows on the trolley 4, the trolley is commanded to move to the left when the joystick 162 is pressed left, and the trolley is commanded to mover right when the joystick 162 is pressed right. In FIG. 16, the operator is facing the opposite direction from FIG. 15 such that the transmitter 160 is oriented forward in the third segment. In the left half of FIG. 16, the joystick 162 is pressed to the right, and the right half of FIG. 16, the joystick is pressed to the left. As illustrated by the arrows on the trolley 4, the trolley is commanded to move to the left when the joystick 162 is pressed right, and the trolley is commanded to move to the right when the joystick 162 is pressed left. Although the directions the joystick 162 is deflected with respect to the transmitter 160 are logically opposite, the trolley 4 will always travel in the same physical direction that the joystick 162 is deflected.

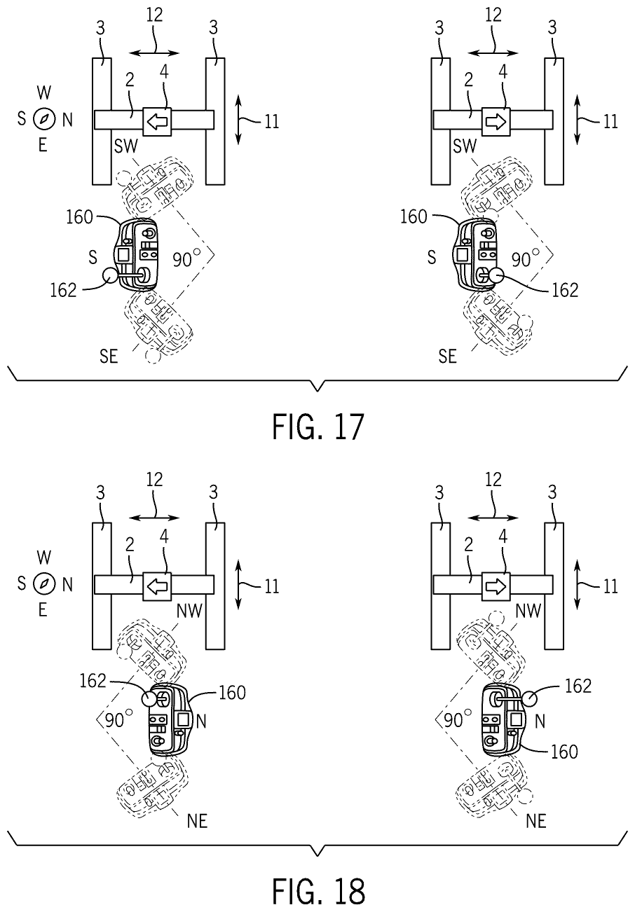

With four segment operation, the trolley 4 may also be commanded by forward and reverse motion of the joystick 162. With reference next to FIGS. 17 and 18, the trolley 4 is commanded by moving the joystick 162 forward or reverse. In FIG. 17, the transmitter 160 is oriented forward in the fourth segment. In the left half of FIG. 17, the joystick 162 is pressed forward, and in the right half of FIG. 17, the joystick 152 is pressed reverse. As illustrated by the arrows on the trolley 4, the trolley is commanded to move to the left when the joystick 162 is pressed forward, and the trolley is commanded to mover right when the joystick 162 is pressed reverse. In FIG. 18, the operator is facing the opposite direction from FIG. 17 such that the transmitter 160 is oriented forward in the second segment. In the left half of FIG. 18, the joystick 162 is pressed reverse, and the right half of FIG. 18, the joystick is pressed forward. As illustrated by the arrows on the trolley 4, the trolley is commanded to move to the left when the joystick 162 is pressed reverse, and the trolley is commanded to move to the right when the joystick 162 is pressed forward. Although the directions the joystick 162 is deflected with respect to the transmitter 160 are logically opposite, the trolley 4 will always travel in the same physical direction that the joystick 162 is deflected.

FIGS. 9-20 illustrate operation of the material handling system 1 with a single joystick 162 controlling both the bridge 2 and the trolley 4. According to another aspect of the invention, a first joystick 162, or paddle, may be provided to move solely in the forward and reverse direction, and a second joystick 162, or paddle, may be provided to move solely in the left and right direction. In the first operating mode, shown in FIGS. 9-12, the first joystick 162, moving forward and reverse, is dedicated to control of the bridge 2, and the second joystick 162, moving left and right, is dedicated to control of the trolley 4. While the orientation of the transmitter 160 will be used in combination to the direction each joystick 162 is deflected to generate motion commands, because there are only two segments, each joystick remains dedicated to controlling a single axis of motion. In the second operating mode, shown in FIGS. 13-20, the two joysticks 162 will alternately control either the bridge 2 or the trolley 4 as the transmitter 160 rotates around the three hundred sixty degree arc. For example, a forward deflection of the first joystick 162 in the first orientation will cause the bridge 2 to travel forward. The same forward deflection of the first joystick 162 in the second orientation will cause the trolley 4 to travel to the right. Thus, a joystick 162 may change the axis of motion being commanded by that joystick based on the orientation of the transmitter 160. However, the direction of the commanded motion will always remain in the same direction as the joystick 162 is deflected.

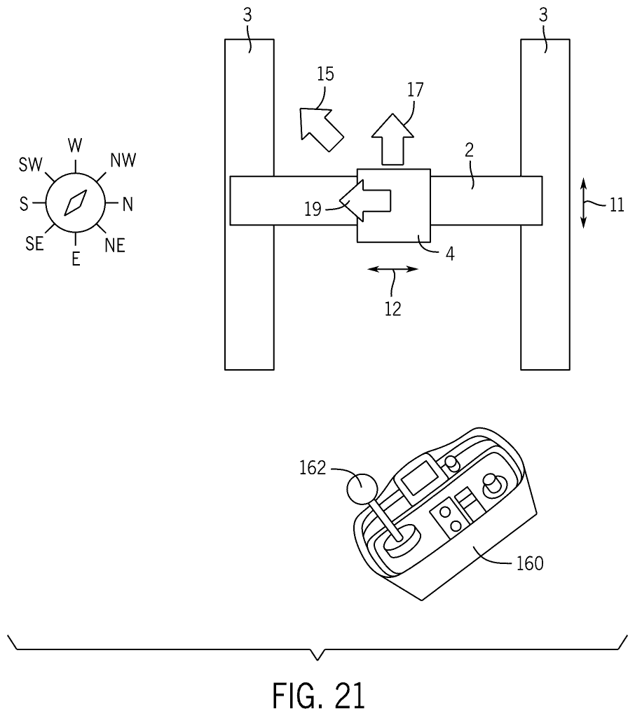

In a third operating mode, the transmitter 160 generates a vector command 15. The vector command 15 is in the direction the joystick 162 is pressed. With reference, for example, to FIG. 21, the front of the transmitter 160 is facing upward and to the left in the figure. This corresponds to a forward direction of the bridge 2 and a left direction for the trolley 4. As illustrated, the joystick 162 is deflected straight forward. The direction the joystick 162 is deflected corresponds to a desired direction of travel by the hook in the material handling system 1. In order for the hook to travel in the direction of the joystick 162, the processor 166 uses the orientation of transmitter 160 to convert the deflection of the joystick 162 into motion commands for both the bridge 2 and the trolley 4.

The radio controller will first determine a magnitude of the deflection of the joystick 162 to determine a desired magnitude of the motion command. An increased amount of deflection may correspond, for example, to an increased desired speed of motion. Having a desired magnitude of the motion command, the radio controller converts the desired motion into motion commands for both the bridge 2 and the trolley 4. If the front of the transmitter 160 is oriented directly in the SW direction, the desired magnitude of the motion command is divided evenly between the bridge 2 and the trolley 4. If the front of the transmitter 160 is oriented between the SW direction and W, then a greater percentage of the desired motion is commanded in the bridge 2 than in the trolley 4. If the front of the transmitter 160 is oriented between the SW direction and S, then a greater percentage of the desired motion is commanded in the trolley 4 than in the bridge 2. However, in either case, the transmitter 160 resolves the vector command into a first command 17 for the bridge 2 and a second command 19 for the trolley 4. In this manner, the hook will travel in whatever direction the joystick 162 is deflected regardless of the orientation of the transmitter 160.

In any of the above operating modes, once motion of the crane 1 has been initiated, control of the crane 1 will remain in the same orientation as which it begins. If the operator, O, moves about during a run of the crane 1, commands will not be reversed because the orientation of the transmitter 160 changes.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A transmitter for a material handling system, comprising:
at least one joystick, wherein:
the at least one joystick is configured to be selectively deflected in a first direction and in a second direction,
the second direction is opposite the first direction,
the at least one joystick is configured to generate a first reference signal corresponding to the first direction, and
the at least one joystick is configured to generate a second reference signal corresponding to the second direction;
a sensor configured to generate at least one feedback signal corresponding to an orientation of the transmitter with respect to a plane of travel for the material handling system;
a memory configured to store a plurality of instructions;
a processor configured to execute the plurality of instructions to:
receive the at least one feedback signal from the sensor,
receive the first and second reference signals from the at least one joystick,
generate a first command signal in a first direction for an axis of motion in the material handling system when the processor receives the first reference signal and the at least one feedback signal defines a first orientation of the transmitter, and
generate a second command signal in the first direction for the axis of motion in the material handling system when the processor receives the second reference signal and the at least one feedback signal defines a second orientation of the transmitter; and
a transceiver configured to transmit the first and second command signals to a receiver for the material handling system.

2. The transmitter of claim 1, wherein:
the axis of motion is a first axis of motion;
the at least one joystick is further configured to be selectively deflected in a third direction and in a fourth direction,
the fourth direction is opposite the third direction,
the at least one joystick is configured to generate a third reference signal corresponding to the third direction, and
the at least one joystick is configured to generate a fourth reference signal corresponding to the fourth direction; and
the processor is further configured to:
receive the third and fourth reference signals from the at least one joystick,
generate a third command signal in a first direction for a second axis of motion in the material handling system when the processor receives the third reference signal and the at least one feedback signal is in the first orientation of the transmitter, and
generate a fourth command signal in the first direction for the second axis of motion in the material handling system when the processor receives the fourth reference signal and the at least one feedback signal is in the second orientation of the transmitter.

3. The transmitter of claim 2, wherein the at least one joystick further comprises:
a first joystick configured to be selectively deflected in the first direction and the second direction, wherein the first joystick generates the first and second reference signals for the first axis of motion; and
a second joystick configured to be selectively deflected in the third direction and the fourth direction, wherein the second joystick generates the third reference signal and the fourth reference signal for the second axis of motion.

4. The transmitter of claim 2, wherein the at least one joystick includes a single joystick configured to be selectively deflected along the first direction and the second direction and the single joystick is also selectively deflected along the third direction and the fourth direction.

5. The transmitter of claim 2, wherein:
the at least one joystick includes a single joystick selectively positioned within a three hundred sixty degree arc; and
the single joystick generates the first reference signal, the second reference signal, the third reference signal, and the fourth reference signal as a function of a present position of the single joystick within the three hundred sixty degree arc.

6. The transmitter of claim 2, wherein:
the transmitter is configured to be selectively oriented in three hundred sixty degrees of rotation;
the three hundred sixty degrees of rotation is divided into a first segment and a second segment;
the first orientation of the transmitter lies within the first segment; and
the second orientation of the transmitter lies within the second segment.

7. The transmitter of claim 2, wherein:
the transmitter is configured to be selectively oriented in three hundred sixty degrees of rotation;
the three hundred sixty degrees of rotation is divided into a first segment, a second segment, a third segment, and a fourth segment;
the first orientation of the transmitter lies within the first segment; and
the second orientation of the transmitter lies within the third segment.

8. The transmitter of claim 7, wherein the processor is further configured to:
generate a fifth command signal in the first direction for the second axis of motion in the material handling system when the processor receives the first reference signal and the at least one feedback signal indicates the transmitter is in the second segment;
generate a sixth command signal in the first direction for the second axis of motion in the material handling system when the processor receives the second reference signal and the at least one feedback signal indicates the transmitter is in the fourth segment;
generate a seventh command signal in the first direction for the first axis of motion in the material handling system when the processor receives the fourth reference signal and the at least one feedback signal indicates the transmitter is in the second segment; and
generate an eighth command signal in the first direction for the first axis of motion in the material handling system when the processor receives the third reference signal and the at least one feedback signal indicates the transmitter is in the fourth segment.

9. A method of controlling a material handling system, comprising the steps of:
receiving a reference signal at a processor from a first joystick on a transmitter for the material handling system, wherein the reference signal is selectively a first reference signal when the first joystick is deflected in a first direction or a second reference signal when the joystick is deflected in a second direction;
receiving a feedback signal at the processor from a sensor mounted in the transmitter, the feedback signal corresponding to an orientation of the transmitter with respect to a plane of travel for the material handling system;
generating a first command signal in a first direction for a first axis of motion in the material handling system when the processor receives the first reference signal and the feedback signal defines a first orientation of the transmitter;
generating a second command signal in the first direction for the first axis of motion in the material handling system when the processor receives the second reference signal and the feedback signal defines a second orientation of the transmitter; and
transmitting the first and the second command signals from the transmitter to a receiver for the material handling system.

10. The method of claim 9, further comprising the steps of:
receiving an additional reference signal at the processor, wherein the additional reference signal is selectively a third reference signal corresponding to a third direction or a fourth reference signal corresponding to a fourth direction;
generating a third command signal in a first direction for a second axis of motion in the material handling system when the processor receives the third reference signal and the feedback signal is in the first orientation of the transmitter; and
generating a fourth command signal in the first direction for the second axis of motion in the material handling system when the processor receives the fourth reference signal and the feedback signal is in the second orientation of the transmitter.

11. The method of claim 10, wherein the transmitter includes a second joystick configured to be selectively deflected in the third direction and the fourth direction, wherein the second joystick generates the third reference signal and the fourth reference signal for the second axis of motion.

12. The method of claim 10, wherein the first joystick is further configured to be selectively deflected along the third direction and the fourth direction to selectively generate the third reference signal or the fourth reference signal.

13. The method of claim 10, further comprising the steps of:
selectively positioning the first joystick within a three hundred sixty degree arc; and
selectively generating the first reference signal, the second reference signal, the third reference signal, and the fourth reference signal as a function of a present position of the first joystick within the three hundred sixty degree arc.

14. The method of claim 9 further comprising the steps of:
selectively orienting the transmitter within three hundred sixty degrees of rotation; and
determining that the transmitter is oriented within either a first segment or a second segment of the three hundred sixty degrees of rotation with the processor as a function of the feedback signal, wherein:
the first orientation of the transmitter lies within the first segment; and
the second orientation of the transmitter lies within the second segment.

15. The method of claim 9 further comprising the steps of:
selectively orienting the transmitter within three hundred sixty degrees of rotation; and
determining that the transmitter is oriented within either a first segment, a second segment, a third segment, or a fourth segment of the three hundred sixty degrees of rotation with the processor as a function of the feedback signal, wherein:
the first orientation of the transmitter lies within the first segment; and
the second orientation of the transmitter lies within the third segment.

16. The method of claim 15 further comprising the steps of:
generating a fifth command signal in the first direction for the second axis of motion in the material handling system when the processor receives the first reference signal and the at least one feedback signal indicates the transmitter is in the second segment;
generating a sixth command signal in the first direction for the second axis of motion in the material handling system when the processor receives the second reference signal and the at least one feedback signal indicates the transmitter is in the fourth segment;
generating a seventh command signal in the first direction for the first axis of motion in the material handling system when the processor receives the fourth reference signal and the at least one feedback signal indicates the transmitter is in the second segment; and
generating an eighth command signal in the first direction for the first axis of motion in the material handling system when the processor receives the third reference signal and the at least one feedback signal indicates the transmitter is in the fourth segment.

17. A transmitter for a material handling system, comprising:
a joystick mounted on the transmitter, wherein the joystick is configured to be selectively deflected forward and reverse in at least a first direction and a second direction;
a sensor configured to generate at least one feedback signal corresponding to an orientation of the transmitter with respect to a plane of travel for the material handling system; and
a processor operative to:
generate a first command signal having a first polarity for a first axis of motion in the material handling system when the joystick is selectively deflected in the first direction and the sensor indicates the transmitter is in a first orientation;
generate the first command signal having a second polarity for the first axis of motion in the material handling system when the joystick is selectively deflected in the first direction and the sensor indicates the transmitter is in a second orientation, wherein the second polarity is opposite the first polarity;
generate a second command signal having a first polarity for a second axis of motion in the material handling system when the joystick is selectively deflected in the second direction and the sensor indicates the transmitter is in the first orientation;
generate the second command signal having a second polarity for the second axis of motion in the material handling system when the joystick is selectively deflected in the second direction and the sensor indicates the transmitter is in the second orientation, wherein the second polarity for the second axis of motion is opposite the first polarity for the second axis of motion.

18. The transmitter of claim 17, wherein:
the transmitter is configured to be selectively oriented in three hundred sixty degrees of rotation;
the three hundred sixty degrees of rotation is divided into a first segment and a second segment;
the first orientation of the transmitter lies within the first segment; and
the second orientation of the transmitter lies within the second segment.

19. The transmitter of claim 17, wherein:
the transmitter is configured to be selectively oriented in three hundred sixty degrees of rotation;
the three hundred sixty degrees of rotation is divided into a first segment, a second segment, a third segment, and a fourth segment;
the first orientation of the transmitter lies within the first segment; and
the second orientation of the transmitter lies within the third segment.

20. The transmitter of claim 19, wherein the processor is further operative to:
generate the first command signal having the first polarity for the first axis of motion in the material handling system when the joystick is selectively deflected in the second direction and sensor indicates the transmitter is oriented in the second segment;
generate the first command signal having the second polarity for the first axis of motion in the material handling system when the joystick is selectively deflected in the second direction and the sensor indicates the transmitter is oriented in the fourth segment;
generate the second command signal having the first polarity for the second axis of motion in the material handling system when the joystick is selectively deflected in the first direction and the sensor indicates the transmitter is oriented in the second segment;
generate the second command signal having the second polarity for the second axis of motion in the material handling system when the joystick is selectively deflected in the first direction and the sensor indicates the transmitter is oriented in the fourth segment.
